(19) United States
(12) Patent Application Publication
(10) Pub. No.: US 2007/0280177 A1
(43) Pub. Date: Dec. 6, 2007

(54) Managing user profile information in a mobile telecommunications network

(75) Inventors: Joanna Uusikartano, Espoo (FI); Atte Lansisalmi, Espoo (FI); Sanna Maenpaa, Espoo (FI); Marko Kuosmanen, Vantaa (FI)

Correspondence Address: FOLEY & LARDNER LLP, P.O. BOX 80278, SAN DIEGO, CA, 92138-0278, US

(73) Assignee: Nokia Corporation

(21) Appl. No.: 11/443,952

(22) Filed: May 31, 2006

(51) Int. Cl. H04Q 7/24

(52) U.S. Cl. 370/338

(57) ABSTRACT

A method of managing user profile information in a mobile telecommunications network comprising a plurality of control nodes which can send signals to, and receive signals from, mobile user equipment, the method comprising the step of transferring user profile information from an old control node to a new control node when a mobile user equipment moves from a detached state to an active state.

### FIELD OF THE INVENTION

The present invention relates to a method of managing user profile information in a mobile telecommunications network. The present invention also relates to a mobile telecommunications network, control nodes for a mobile telecommunications network, a computer program and a computer program product adapted to implement the aforementioned method.

### BACKGROUND OF THE INVENTION

A communication system can be seen as a facility that enables communication sessions between two or more entities such as mobile user equipment and/or other nodes associated with the communication system. The communication may comprise, for example, communication of voice, data, multimedia and so on. Communication systems providing wireless communication for user equipment are known. Cellular communication systems are configured to have a cell structure, and typically they support communication with mobile user equipment changing locations (mobile users). The support for communications for mobile users may include support for handing existing connections from one cell to another cell. At least routing of calls or communications for a mobile user in a new cell is typically supported in cellular systems. Non-limiting examples of a cellular system are the Global System for Mobile Telecommunications (GSM) and General Packet Radio Service (GPRS).

Packet-switched networks are those in which relatively small units of data called packets are routed through the network based on a destination address contained within each packet. Breaking communication down into packets allows the same data path to be shared among many users in the network. GPRS provides packet-switched data services and typically utilizes the infrastructure of a GSM network.

A cellular network is a radio network of individual cells, known as base stations. Each base station covers a small geographical area, and is uniquely identified by a location area code. By integrating the coverage of each of these base stations, a cellular network provides radio coverage over a very much wider area. A group of base stations is called a location area, or a routing area.

A “location area” is a set of base stations that are grouped together to optimise signalling. Typically, 10s or even 100s of base stations share a single controller, for example a Base Station Controller (BSC). The controller handles allocation of radio channels, receives measurements from the mobile phones, and controls handovers from base station to base station.

To each location area, a unique number called a “location area code” is assigned. The location area code is broadcast by each base station at regular intervals. A location update procedure allows a mobile device to inform the cellular network, whenever it moves from one area to the next. The mobile user equipment are responsible for detecting location area codes. When a mobile user equipment finds that the location area code is different from its last update, it performs another update by sending to the network, a location update request.

A “routing area” is a subdivision of a “location area”. Routing areas are used by mobiles which are using packet-switched data services. The bursty nature of packet traffic means that more paging messages are expected per mobile, and so it is worth to know the location of the mobile more accurately than it would be with traditional circuit-switched traffic. A change from routing area to routing area (called a “Routing Area Update” (RAU)) is done in an almost identical way to a change from location area to location area. The main difference is that an element such as a “Serving GPRS Support Node” (SGSN) or similar is involved. A RAU procedure thus allows a mobile device to inform the cellular network, whenever it moves from one routing area to the next served by a different SGSN. Mobiles are responsible for detecting routing area codes. When a mobile finds that the routing area code is different from its last update, it performs another update by sending to the network, a RAU request.

A handover minimizes the service interruption times by allowing continuous data transfer between a user equipment and a cellular system when the user equipment is moving from one cell to another cell. A packet-switched handover may be an intra-SGSN handover or an inter-SGSN handover. In an intra-SGSN handover, the source and target base station are controlled by the same SGSN. In an inter-SGSN handover, the source base station is controlled by a first (source) SGSN and the target base station is controlled by a second (target) SGSN.

A GPRS mobile will perform a Routing Area Update in the Ready and Standby GPRS states, and in Packet Mobility Management (PMM)-IDLE and PMM-ACTIVE Iu mode states, respectively. The RAU is triggered when the mobile crosses a RA (Routing Area) boundary, or periodically with the time interval being set by the network. A RAU is also performed when the mobile moves from the Idle to the Standby state. This will typically happen when the mobile is powered on.

A packet data protocol (PDP) context refers to information sets held in the user equipment and GPRS Supporting Nodes (GSNs) that are used to bind the user equipment to a PDP address that identifies an application, PDP type and a QoS (Quality of Service) profile. That is, the PDP context is a logical association between a user equipment and PDN (Public Data Network) running across a GPRS network defining aspects such as Routing, QoS, Security, Billing etc. PDP context functions are discussed in, for example, 3^{rd} Generation Partnership Project Technical Specification 29.060 (3GPP TS 29.060).

Other types of packet switched networks are known. For example, Universal Mobile Telecommunications System (UMTS) is one of the third-generation (3G) mobile phone technologies. The supporting nodes in this system may be designated 3G-GSNs with the serving support node designated 3G-SGSN. In UMTS, a packet switched signalling connection is a peer-to-peer UMTS connection between the user equipment and 3G-SGSN. It consists of an RRC (Radio Resource Control) connection and an Iu connection. In 3G mobile phone technologies, the interface between the access node and a node in the core network is denoted as an Iu interface. Over the Iu interface, connections can be established according to the Iu user plane protocol.

The packet switched signalling connection is needed in UMTS packet domain in order to send signalling messages (e.g. Activate PDP Context Requests) or user data. 3G-SGSN may release the packet switched signalling connection, for instance after a GMM (GPRS Mobility Management) specific signalling procedure (e.g. Routing Area Update), or it can prolong the connection for the following activity.

The Home Location Register/Home Subscriber Server (HLR/HSS) is a central database that contains details of each mobile phone subscriber (user profile information) that is authorized to use the network. More precisely, the HLR/HSS stores details of every SIM card issued by the mobile phone operator. Each SIM has a unique identifier called an IMSI which is one of the primary keys to each HLR/HSS record. The user profile information also comprises the telephone numbers used to make and receive calls to the mobile phone, known as MSISDNs. The main MSISDN is the number used for making and receiving voice calls and SMS, but it is possible for a SIM to have other secondary MSISDNs associated with it for fax and data calls. Each MSISDN may also be a primary key to the HLR/HSS record.

Examples of other user profile information stored in the HLR/HSS in a SIM record include: GSM services that the subscriber has requested or been given; GPRS settings to allow the subscriber to access packet services; current location of subscriber (Visitor Location Register (VLR) and SGSN); and call divert settings applicable for each associated MSISDN. The HLR/HSS data is stored for as long as a subscriber remains with the mobile phone operator.

At first glance, the HLR/HSS seems to be just a database which is merely accessed by other network elements which do the actual processing for mobile phone services. In fact the HLR/HSS is a system which directly receives and processes transactions and messages. If the HLR fails, then the mobile network is effectively disabled as it is the HLR/HSS which manages the Location Updates as mobile phones roam around.

As the number of mobile subscribers has grown, so the HLR/HSS has become a more powerful computer server rather than the traditional telephone exchange hardware in the early days of GSM. The main function of the HLR/HSS is to manage the fact that SIMs and phones move around a lot. In CS domain, the HLR/HSS can manage the mobility of subscribers by means of updating their position in location areas identified with a location area code as previously described. The action of a user of moving from one location area to another is followed by the HLR/HSS with a location area update. For the PS domain, HLR/HSS knows the SGSN the subscriber is attached to. The user profile information is sent to a serving node (control node) when a subscriber first roams there.

Thus, when a handover is performed from one serving node to another serving node, the user profile information can be transferred to the new serving node from the old serving node. The user profile information may then be removed from the old serving node. However, if a mobile user equipment is detached from the network, e.g. when the mobile user equipment is idle or switched off, a handover does not occur when moving from one location or routing area to another. Thus, when a mobile user equipment moves from a detached state to an active state, e.g. by powering on, a location/routing area update will be performed and user profile information is fetched form the HLR/HSS to the serving node. Accordingly, a problem with the current network arrangements is that each time a mobile user equipment moves from a detached state to an active state, the user profile must be fetched to the new control node from the HLR/HSS. This can cause congestion and an undue signalling burden between the HLR/HSS and mobile user equipment.

The present invention aims to solve the aforementioned problem by reducing the signalling burden between the Core network node controlling mobile user equipment and the HRL/HSS.

### SUMMARY OF THE INVENTION

The present inventors have deduced that repeatedly transferring large files between a new control node and the HLR/HSS results in an undue burden on the network, as the HLR/HSS is a central control point of the network. Having deduced this, the problem becomes how to reduce this burden by distributing it in the network. The present inventors have solved this problem by providing an arrangement in which rather than fetching the user profile from the HLR/HSS to the new control node each time a mobile user equipment moves from a detached state to an active state, the user profile information is transferred from an earlier control node (e.g. an earlier SGSN) in the case that it is still saved there.

In light of the above, according to a first aspect of the present invention there is provided a method of managing user profile information in a mobile telecommunications network comprising a plurality of nodes which can send signals to, and receive signals from, mobile user equipment, the method comprising the step of transferring user profile information from an old control node to a new control node when a mobile user equipment moves from a detached state to an active state.

The old control node will usually be the last node to which the mobile user equipment was associated with prior to detachment from the mobile telecommunications network by, for example, powering down. The new control node will be the node to which the mobile user equipment associates when it re-attaches to the mobile telecommunications network by, for example, powering on. The control nodes may be SGSN, or any other control node that fetches user information from a central network node depending on the particular type of mobile communications network in which the present invention is implemented.

When a user attaches (moves from detached to active state), the control node needs to get the subscriber information from somewhere if the subscriber was not attached earlier in the very same node and the node still has the subscription data saved. The normal place to get the subscription data is a centralised HLR/HSS. The present invention makes it possible to exchange smaller messages between the new control node and the HLR/HSS by direct delivery of subscriber profile information between control nodes and to distribute the signalling load related to user profile fetching. The invention can be considered to be an optimisation of the inter control node interface instead of loading the interface between the control node and the HLR/HSS. By, transferring the user profile information from the old control node to the new control node, this information need not be accessed from the HLR/HSS.

The control node in any case has to make a dialog to the HLR at some stage, at least in order to update the mobile user equipment location to the HLR. However, some savings in message size are achieved by transferring the mobile user equipment profile data directly from the old control node instead of fetching it from the HLR. The subscriber profile may still be stored in the old control node if purge from the old control node is not yet performed. The saving in message size can help as at least narrowband links between a current control node and the HLR/HSS are reasonably slow. Also, the HLR/HSS is a centralised element and distributing any possible data that could also be fetched from somewhere else can help in the case of, for example, congestion.

The invention does not restrict current behaviour either. For example, in the case that the new control node receives user profile information from HLR/HSS, and if any changes are detected, the user profile information from the HLR/HSS may override the profile from the old control node. For example, the user profile information might have just been updated in the HLR/HSS. Furthermore, the present invention assumes that the user profile is kept at the old control node for some time before removal (can be assumed from any reasonable implementation). According to an embodiment of the present invention, if the user profile information has already been removed form the old control node then the user profile information is fetched from the HLR/HSS.

### BRIEF DESCRIPTION OF THE DRAWINGS

For a better understanding of the present invention and to show how the same may be carried into effect, embodiments of the present invention will now be described by way of example only with reference to the accompanying drawings, in which:

FIG. 1 shows schematically a cellular communication system with which embodiments of the invention can be used;

FIG. 2 shows an attachment procedure;

FIG. 3 shows the information elements in a prior art identification response;

FIG. 4 shows the information elements in an identification response according to an embodiment of the present invention;

FIG. 5 shows the subscribed PDP Context information elements which may be incorporated in the identification response illustrated in FIG. 4; and

FIGS. 6 to 10 show embodiments of MM Context information elements that may be utilized in embodiments of the present invention.

### DETAILED DESCRIPTION OF THE PREFERRED EMBODIMENTS OF THE INVENTION

The invention will be described in relation to a 3G-GPRS system. However, it will be understood that the present invention is not limited to this particular implementation.

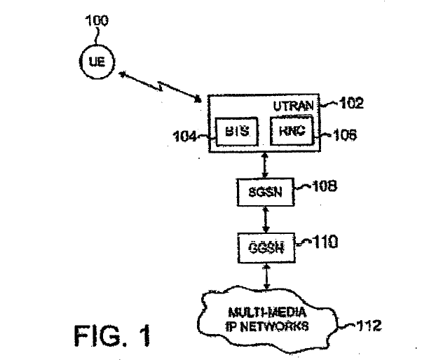

Referring to FIG. 1, there is illustrated the main elements of a UMTS network. It should be noted that FIG. 1 does not represent a full implementation of a UMTS network, which implementation will be familiar to one skilled in the art. Rather, FIG. 1 represents some of the main elements of such a UMTS network necessary for placing the present invention into an appropriate context.

A user equipment (UE) 100 communicates over a radio interface with a UTRAN (UMTS radio access network) 102. As is known in the art, the UTRAN 102 includes a base transceiver station (BTS) 104 and a radio network controller (RNC) 106. In the UMTS network the UTRAN 102 is connected to a serving GPRS support node (SGSN) 108, which in turn is connected to a gateway GPRS support node (GGSN) 110. The GGSN 110 is further connected to at least one external network, e.g. multimedia IP network, represented by reference numeral 112 in FIG. 1. Both the SGSN and the GGSN may be considered to be network elements.

In general terms, a PDP context is activated in order to establish a logical connection between a user equipment and the GGSN.

In known implementations, the UE 100 initiates a logical connection by requesting a PDP context activation by transmitting session management messages to the SGSN 108 via the UTRAN 102. Responsive thereto, the SGSN 108 requests RAB (radio access bearer) establishment from the RNC 106 using the radio access network application protocol (RANAP). The SGSN 108 also requests PDP context creation with GPRS tunneling protocol (GTP) from the GGSN 1 10. This procedure is repeated for each PDP context which the UE 100 requires.

As well as requesting PDP context activation, the UE 100 may also request secondary PDP context activations, PDP context modifications, or PDP context deactivations. The specific implementation of PDP context activations, secondary PDP context activations, PDP context modifications, and PDP context deactivations is well known in the art.

Embodiments of the present invention which can be implemented in the previously described system are now described in more detail.

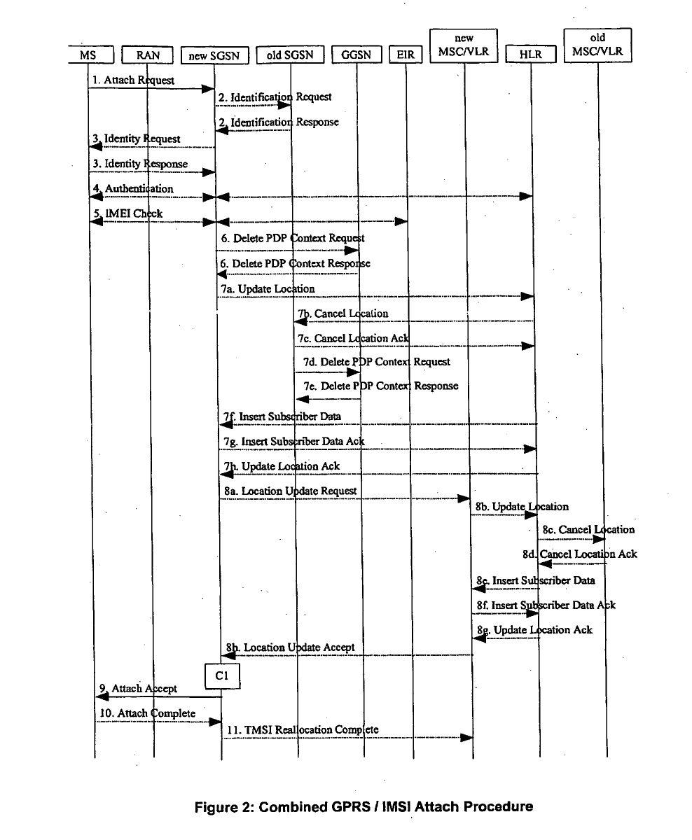

In 3GGP TS 23.060, an attachment procedure is described and is illustrated in FIG. 2. In this attachment procedure, in response to an Attachment Request, the new SGSN sends an Identification Request to the old SGSN. The old SGSN subsequently sends an Identification Response back to the new SGSN. In the arrangement described in 3GPP TS 29.060 v6.11.0, when moving from a detached state to an active state, in, for example, 2G/3G mobile telecommunications networks, only user id (International Mobile Subscriber Identity—IMSI) and authentication vectors are transferred from the old control node (e.g. old SGSN) to the new control node (e.g. new SGSN). This is to protect the IMSI from hijackers on the radio link. When a mobile user equipment re-attaches with a Packet-Temporary Mobile Subscriber Identity (P-TMSI) and the IMSI is transferred from the old control node to the new control node, a users IMSI does not have to be transferred in clear text on the first message (Attach request).

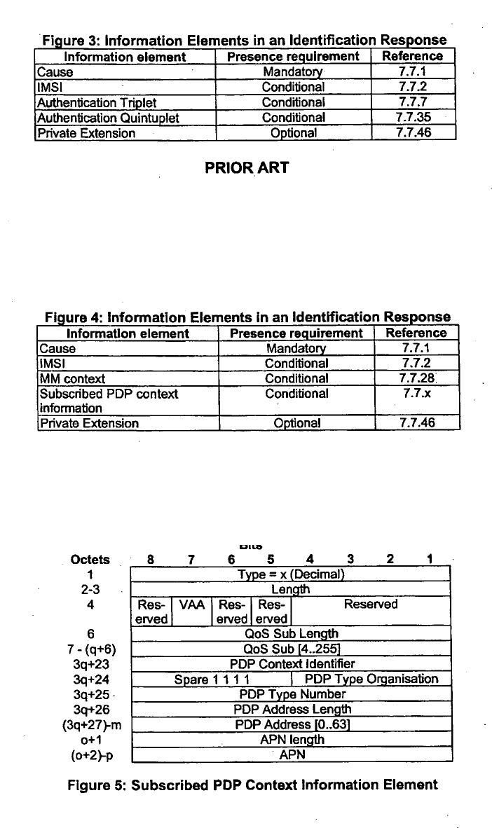

However, in the aforementioned arrangement, the rest of the information required at the new control node, including subscriber profiles, is fetched from a centralised node (HLR/HSS). The information elements in the prior art Identification Response are illustrated in FIG. 3.

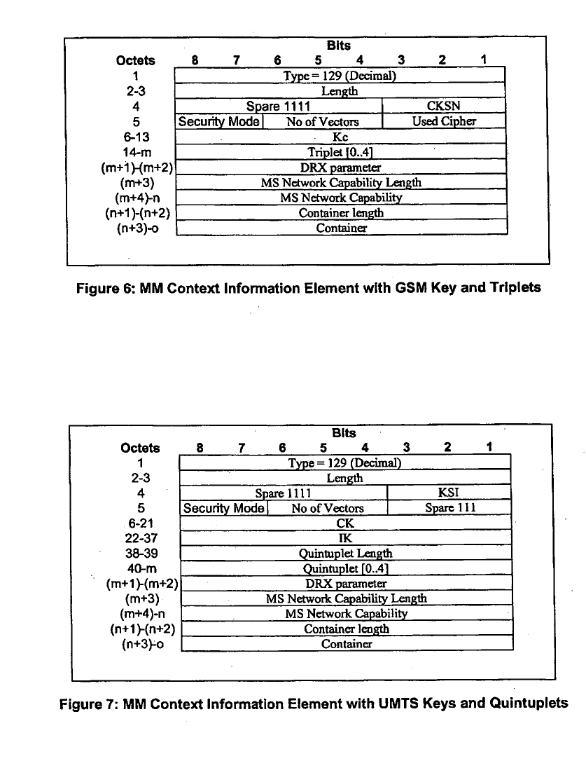

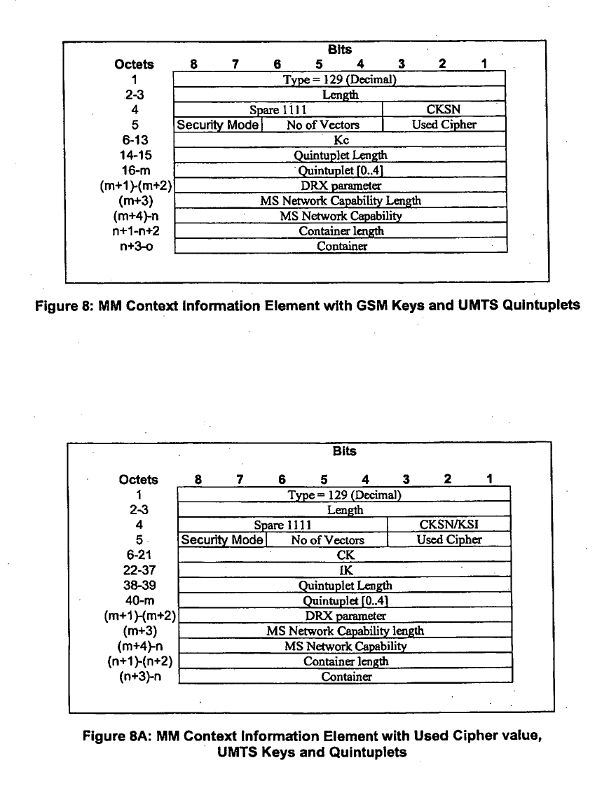

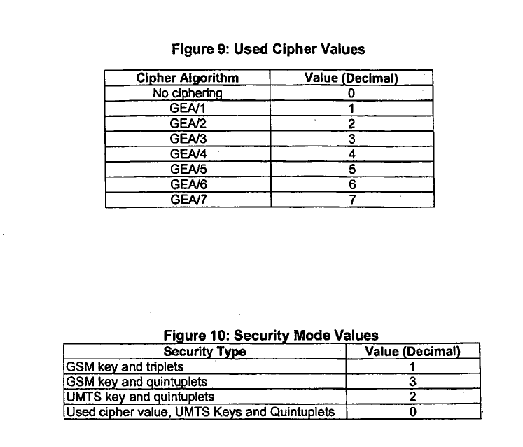

Embodiments of the present invention add new data to existing Identification Request/Response dialog. Instead of only IMSI and Authentication Triplet/Quintuplet, the Identification Response can contain full MM context information elements as well as subscribed PDP context information. The information elements in such an Identification response are illustrated in FIG. 4. Information elements in a subscribed PDP Context are illustrated in FIG. 5 and MM context information elements (referred to as 7.7.28 MM Context in 3GPP TS 29.060) are illustrated in FIGS. 6 to 10.

Embodiments of the invention propose to add full Mobility Management context to Identification Response messages as well as subscribed PDP context information. It can be considered as an optimization to the current solution while not restricting current behaviour.

Although described above in relation to a 3G-GPRS system, embodiments of the present invention can also be applied in other network systems such as 2G GPRS, Long Term Evolution (LTE), and System Architecture Evolution (SAE) arrangements. SAE provides seamless services to mobile users, beyond mere IP-level connectivity. SAE has three components relevant to the present invention: the registration of application context information with a current Mobility Management Entity (MME); the possible transfer of the context information to a new MME in case of handover; and the appropriate handling of the information at the new MME. The registration protocol establishes the application context information with the current MME. The context transfer protocol facilitates proactive pushing and reactive pulling of the application context information from the old MME to the new MME. Finally, the module in the new MME that is responsible for processing the application context information extracts the relevant information from the received application context information and invokes appropriate actions, which are specific for the application. Embodiments of the present invention may be very useful in this System Architecture Evolution.

The required data processing functions may be provided by means of one or more data processor entities. All required processing may be provided in the control nodes (e.g. the SGSN). Appropriately adapted computer program code product may be used for implementing the embodiments, when loaded to a computer, for example for computations required when monitoring for improperly switched user equipments and analysis of the users thereof. The program code product for providing the operation may be stored on and provided by means of a carrier medium such as a carrier disc, card or tape. A possibility is to download the program code product via a data network. Implementation may be provided with appropriate software in a server.

While this invention has been particularly shown and described with reference to preferred embodiments, it will be understood to those skilled in the art that various changes in form and detail may be made without departing from the scope of the invention as defined by the appendant claims.

1-34. (canceled)

35. A method of managing user profile information in a mobile telecommunications network comprising a plurality of control nodes which can send signals to, and receive signals from, mobile user equipment, the method comprising transferring user profile information from an old control node to a new control node when a mobile user equipment moves from a detached state to an active state.

36. A method according to claim 35, wherein the step of transferring user profile information from the old control node to the new control node when a mobile user equipment moves from a detached state to an active state comprises: sending an attach request to the new control node; sending a request from the new control node to the old control node; and sending an response from the old control node to the new control node, the response comprising the user profile information.

37. A method according to claim 35, wherein the old control node is the last node to which the mobile user equipment was associated with prior to moving into the active state.

38. A method according to claim 35, wherein the old control node and the new control node are Serving General Packet Radio Service Support Nodes or Mobility Management Entities.

39. A method according to claim 35, wherein if the user profile information is not present in the old control node then the user profile information is obtained from a home location register or home subscriber server.

40. A method according to claim 36, wherein if the user profile information is not present in the old control node then the user profile information is obtained from a home location register or home subscriber server and wherein the response comprises an indicator that the user profile information has been removed from the old control node, said indicator prompting the new control node to interrogate the home location register or home subscriber server to obtain the user profile information.

41. A method according to claim 35, wherein the user profile information in the old control node is obtained from the home location register or home subscriber server.

42. A method according to claim 41, wherein the new control node receives user profile information from a home location register or home subscriber server, and if any changes in the user profile information are detected, the user profile information from the home location register or home subscriber server overrides the user profile information received from the old control node.

43. A method according to claim 35, wherein the user profile information comprises subscribed Packet Data Protocol context information.

44. A method according to claim 35, wherein the user profile information comprises Mobility Management context information related to subscription.

46. A mobile telecommunications network comprising a plurality of control nodes which can send signals to, and receive signals from, mobile user equipment, the mobile telecommunications network being arranged to transfer user profile information from an old control node to a new control node when a mobile user equipment moves from a detached state to an active state.

47. A mobile telecommunications network according to claim 46, wherein the new control node is arranged to send a request to the new control node on receiving an attach request from the mobile user equipment and the old control node is arranged to send a response to the new control node, the response comprising the user profile information.

48. A mobile telecommunications network according to claim 46, wherein the old control node is the last node to which the mobile user equipment was associated with prior to moving into the active state.

49. A mobile telecommunications network according to claim 46, wherein the old control node and the new control node are Serving General Packet Radio Service Support Nodes or Mobility Management Entities.

50. A mobile telecommunications network according claim 46, wherein if the user profile information is not present in the old control node then the new control node is arranged to obtain the user profile information from a home location register or home subscriber server.

51. A mobile telecommunications network according to claim 47, wherein if the user profile information is not present in the old control node then the new control node is arranged to obtain the user profile information from a home location register or home subscriber server and wherein the response comprises an indicator that the user profile information has been removed from the old control node, said indicator prompting the new control node to interrogate the home location register or home subscriber server to obtain the user profile information.

52. A mobile telecommunications network according to claim 46, wherein the user profile information in the old control node is obtained from the home location register or home subscriber server.

53. A mobile telecommunications network according to claim 52, wherein the new control node is arranged to receive user profile information from a home location register or home subscriber server, and if any changes in the user profile information are detected, the user profile information from the home location register or home subscriber server overrides the user profile information received from the old control node.

54. A mobile telecommunications network according to claim 46, wherein the user profile information comprises subscribed Packet Data Protocol context information.

55. A mobile telecommunications network according to claim 46, wherein the user profile information comprises Mobility Management context information related to user subscription.

56. A control node for a mobile telecommunications network, the control node being arranged to interrogate an old control node for user profile information in response to an attachment request from a mobile user equipment.

57. A control node according to claim 56, wherein the control node is a Serving General Packet Radio Service Support Node or Mobility Management Entity.

58. A control node according to claim 56, wherein if the user profile information is not present in the old control node then the control node is arranged to obtained the user profile information from a home location register.

59. A control node according to claim 56, wherein the user profile information in the old control node is obtained from the home location register or home subscriber server.

60. A control node according to claim 59, wherein the control node is arranged to receive user profile information from both the old control node and the home location register or home subscriber server, and if any changes in the user profile information are detected, the user profile information from the home location register or home subscriber server overrides the user profile information received from the old control node.

61. A control node according to claim 56, wherein the user profile information comprises subscribed Packet Data Protocol context information.

62. A control node according to claim 56, wherein the user profile information comprises Mobility Management context information related to user subscription.

63. A control node for a mobile telecommunications network, the control node being arranged to send user profile information in response to a request from a new control node.

64. A control node according to claim 63, wherein the control node is a Serving General Packet Radio Service Support Node or Mobility Management Entity.

65. A control node according to claim 63, wherein if the user profile information is not present in the control node then the control node is arranged to send an indictor to the new control node that the user profile information should be obtained from a home location register or home subscriber server.

66. A control node according to claim 63, wherein the user profile information comprises subscribed Packet Data Protocol context information.

67. A control node according to claim 63, wherein the user profile information comprises Mobility Management context information related to user subscription.

68. A computer program product comprising program code means stored in a computer readable medium, the program code means being adapted to transfer user profile information from an old control node to a new control node when a mobile user equipment moves from a detached state to an active state.

69. A computer program product according to claim 68, wherein transferring user profile information from the old control node to the new control node when a mobile user equipment moves from a detached state to an active state comprises: sending an attach request to the new control node; sending a request from the new control node to the old control node; and sending an response from the old control node to the new control node, the response comprising the user profile information.

70. A computer program product to claim 68, wherein the old control node is the last node to which the mobile user equipment was associated with prior to moving into the active state.

71. A computer program product according to claim 68, wherein the old control node and the new control node are Serving General Packet Radio Service Support Nodes or Mobility Management Entities.

72. A computer program product according to claim 68, wherein if the user profile information is not present in the old control node then the user profile information is obtained from a home location register or home subscriber server.

73. A computer program product according to claim 69, wherein if the user profile information is not present in the old control node then the user profile information is obtained from a home location register or home subscriber server and wherein the response comprises an indicator that the user profile information has been removed from the old control node, said indicator prompting the new control node to interrogate the home location register or home subscriber server to obtain the user profile information.

74. A computer program product according to claim 68, wherein the user profile information in the old control node is obtained from the home location register or home subscriber server

75. A computer program product according to claim 74, wherein the new control node receives user profile information from a home location register or home subscriber server, and if any changes in the user profile information are detected, the user profile information from the home location register or home subscriber server overrides the user profile information received from the old control node.

76. A computer program product according to claim 68, wherein the user profile information comprises subscribed Packet Data Protocol context information.

77. A computer program product according to claim 68, wherein the user profile information comprises Mobility Management context information related to subscription.
